(19) United States
(12) Patent Application Publication
(10) Pub. No.: US 2021/0278865 A1
(43) Pub. Date: Sep. 9, 2021

(54) THERMAL REGULATING VALVE

(71) Applicant: Gebr. Kemper GmbH + Co. KG, Olpe (DE)

(72) Inventor: Paul Cordes, Lennestadt (DE)

(21) Appl. No.: 17/189,320

(22) Filed: Mar. 2, 2021

(30) Foreign Application Priority Data
Mar. 3, 2020 (DE) 20 2020 000 872.9

(51) Int. Cl. G05D 23/02

(52) U.S. Cl. CPC G05D 23/026

(57) ABSTRACT

The present invention relates to a regulating valve for water circulation systems, comprising a valve housing (2) having an inlet channel (1) and an outlet channel (3) and forming a valve seat (4) between the inlet channel (1) and the outlet channel (3), a regulating member (36) movable relative to the valve seat (4) for regulating a water flow rate, and an expansion element (40) controlled by a water temperature for placement control of the regulating member (36). The present invention wants to provide an improved regulating valve for regulating the water flow in water circulation systems and proposes that a valve seat cage (28) bearing against the valve seat (4) during a regulating operation forms a flow-through opening (62) relative to which the regulating member (36) is movable, the regulating member (36) being pivotable about its positioning axis (S) for presetting a regulating gap (84) between the regulating member (36) and the valve seat cage (28).

The present invention relates to a regulating valve having the features according to the preamble of claim 1. Such a regulating valve is known from DE 10 2005 038 699 B4 and DE 10 2006 059 577 B4.

The regulating valve known from DE 10 2005 038 699 B4 is adapted for regulating a flow of water through hot water pipes with hot water circulation. In a valve housing of the regulating valve, an expansion element is provided as a thermal placement element, which adjusts a plunger depending on the water temperature relative to a valve seat formed between an inlet channel and an outlet channel of the valve housing. The volume flow through the regulating valve can be reduced to a residual volume flow from a water temperature that can be adjusted from outside via an operating element. For this purpose, the valve seat has provided therein a valve closure piece with an inflow opening, with which the plunger cooperates so as to regulate the water flow rate. The valve closure piece has a radially opening outflow opening that can be brought into overlap with one of differently sized flow-through openings of an adjusting sleeve, which overlaps the valve closure piece circumferentially and can be turned relative to the valve closure piece.

DE 10 2006 059 577 B4 further develops the regulating valve known from DE 10 2005 038 699 B4 by providing a setting device used for turning the adjusting sleeve and accessible from outside.

The known regulating valves offer room for improvement.

It is an object of the present invention to provide an improved regulating valve for regulating the water flow in water circulation systems.

To solve this problem, the present invention discloses a regulating valve for water circulation systems having the features of claim 1.

In particular, the regulating valve according to the present invention is also adapted for regulating a flow of water through hot water pipes with hot water circulation. In principle, however, it can also be used in cold water pipes with cold water circulation.

The regulating valve according to the present invention is characterized in that a valve seat cage bearing against the valve seat during a regulating operation forms a flow-through opening relative to which the regulating member is movable, the regulating member being pivotable about its positioning axis for presetting a regulating gap between the regulating member and the valve seat cage. The regulating member is normally arranged between the expansion element and the valve seat cage, between which also the positioning axis of the regulating member extends. The regulating member provided is usually an elongate valve body, such as a plunger, which is applied against the expansion element under pretension. In a manner known per se, the expansion element expands against the pretension, when the temperature increases, and moves the regulating member in the direction of the positioning axis towards the flow-through opening, so that the water flow rate through the flow-through opening will be reduced. When the temperature decreases, the expansion element contracts accordingly and the regulating member moves away from the flow-through opening due to the pretension, so that the water flow rate through the flow-through opening will increase again. For stabilizing this positioning movement, the housing has usually provided therein means for guiding the regulating member.

During a regulating operation, the valve seat cage bears against the valve seat. The contact is usually of such a nature that, apart from a possibly existing leakage flow between the contact surfaces of the valve seat cage and the valve seat, the entire water flow rate flows through the flow-through opening of the valve seat cage. During the regulating operation, the water temperatures are in a range that is the normal range for a hot water circulation pipe, preferably approx. 50-65° C. The position of the valve seat cage does not undergo any positioning movement during the regulating operation. The regulation of the water flow rate during the regulating operation usually takes place exclusively through a positioning movement of the regulating member.

The position of the expansion element can be adjusted from outside by means of a setting device. In this way, it will be possible to set from outside a water temperature at which the regulating member bears against the valve seat cage during the regulating operation and the water flow rate is reduced to a residual volume flow, which flows through a regulating gap between the regulating member and the valve seat cage. The magnitude of the residual volume flow is usually selected such that the heat losses of hot water circulation can be compensated for. This will ensure circulation of hot water at all times, so that no water can stand and cool down in the hot-water piping system.

The length of the respective pipes as well as the overall size of hot water circulation systems are sometimes different, so that the required residual volume flow will vary depending on the structural design of the circulation system. The residual volume flow can therefore be adjusted with the regulating valve according to the present invention by presetting the regulating gap. For this purpose, the regulating member can be pivoted about its positioning axis. The contours of the flow-through opening and of the axial end of the regulating member cooperating with the flow-through opening are adapted to each other in such a way that the size of the regulating gap will be changed by pivoting the regulating member about its positioning axis. This means that the regulating member closes the flow-through opening to different degrees depending on the angle by which the regulating member has been pivoted about its positioning axis. According to the present invention, the use of a rotatable adjustment sleeve, which cooperates with the valve seat cage inserted in the valve seat and surrounds it circumferentially on the outside, can be dispensed with, since the regulating member itself is adapted to be pivoted about its positioning axis for presetting a regulating gap.

According to a preferred further development of the present invention, the regulating gap can be varied stepwise by pivoting the regulating member. Accordingly, the contours of the flow-through opening and of the axial end of the regulating member cooperating with the flow-through opening are preferably adapted to one another such that a respective one of differently sized, angularly spaced regulating gaps can be uncovered by pivoting the regulating member about its positioning axis. Normally, the size of the regulating gaps increases by pivoting the regulating member in one direction and decreases by pivoting the regulating member in the other direction. Particularly preferred, the regulating member is pivotable through essentially 360°. Very preferably, the regulating member is rotatable. In this case, the above-described relation to the change in size of the regulating gap exhibits an exception that occurs at a point lying between the minimum and the maximum regulating gap.

In this way, the regulating valve according to the present invention allows switching between a plurality of regulating gaps of a fixedly predetermined size. Preferably, each of the regulating gaps has assigned thereto a corresponding mark on a setting device for pivoting the regulating member, i.e. for presetting the regulating gap, the setting device being operable from outside. Further preferred, the setting device is adapted to be locked at spaced-apart angular positions, which correspond to the angular positions of the regulating gap.

According to another preferred further development of the present invention, the regulating member cooperates with a base of the valve seat cage, which is provided with the flow-through opening, for regulating the water flow rate. The regulating gap is here defined by a part of the flow-through opening which, when the regulating member bears against the base, is not covered by the regulating member. Usually, the valve seat cage has a lower ring circumferentially surrounding the base and carrying on its outer side a seal which, during the regulating operation, bears against the valve seat of the valve housing. An upper ring of the valve seat cage according to this preferred further development is connected to the lower ring via webs. The regulating member is passed through the upper ring. Water flowing into the valve seat cage through the flow-through opening and the regulating gap, respectively, will usually exit the valve seat cage through at least one of the transverse openings formed by the webs.

For guiding the regulating member in the direction of its positioning axis, a guide sleeve is usually provided, which is held in the valve housing and is connected at a free end to the valve seat cage and thus carries the valve seat cage, the regulating member being passed through the free end of the guide sleeve. The regulating member is slidably guided and sealed in the guide sleeve. The valve seat cage is preferably manufactured as a separate component and connected to the guide sleeve, so that a cap of increased width, which is provided at the free axial end of the regulating member and which cooperates with a base of the valve seat cage, is enclosed in the valve seat cage.

According to another preferred further development of the present invention, the axial end of the regulating member cooperating with the base is conical. According to this preferred further development, the base of the valve seat cage is also conical and forms a counter-cone to the free conical end of the regulating member. The contact between the regulating member and the base of the valve seat cage can be improved in this way. In addition, contaminations and dirt can thus less easily adhere to the flow-through opening.

According to another preferred further development according to the present invention, the flow-through opening of the base of the valve seat cage has a center hole from which differently sized slots extend in a radial direction. When the regulating member bears against the base of the valve seat cage, the center hole and, with the exception of one slot, all slots can normally be covered by the regulating member. The regulating gap is thus usually formed by the uncovered or at least not completely covered slot. The center hole is preferably circular. The slots are preferably rectangular or semicircular and differ from one another in their length and/or width.

According to another preferred further development of the present invention, the conical end of the regulating member has a cutout, which usually extends radially inwards from the circumference of a cap of increased width and which is adapted to be brought into overlap or overlay with one of the slots by pivoting the regulating member so as to adjust the regulating gap stepwise.

The width of the cutout in the circumferential direction of the cone is usually greater than the smallest distance between two slots and not greater than twice the distance between two slots. This means that the cutout will always expose at least and at most one of the slots completely, or at least and at most two slots partially. Shutting off the regulating valve by incorrectly operating the setting device is thus not possible. Usually, the setting device can be lockingly engaged in such a way that the cutout will always expose precisely one of the slots.

According to another preferred further development of the present invention, the valve seat cage can, in a disinfecting operation for thermal disinfection of the regulating valve, be moved, at least partially, to a valve seat side located opposite the expansion element. Due to the placement of the expansion element, the contact between the valve seat cage and the valve seat will in this case cease to exist at very high water temperatures and an opening for the flow of water between the valve seat cage and the valve seat will be opened. In spite of the fact that the water flow rate through the flow-through opening of the valve seat cage is reduced to a residual volume flow at high water temperatures, it will thus be possible to flush the regulating valve with a large volume flow for thermal disinfection and very high water temperatures. Further preferred, the lower ring of the valve seat cage that forms a free end of the valve seat cage and has at its outer circumference a seal, which cooperates with the valve seat and which is preferably a sealing ring, is forced through a passage opening of the housing by the regulating member during the disinfecting operation, the passage opening of the housing being defined by the valve seat. At a very high water temperature sufficient for thermal disinfection (usually higher than 65° C.), the regulating member positioned by the thermal expansion element and bearing against the base of the valve seat cage will entrain the valve seat cage and push it out of the valve seat. Usually, this also has the effect that the guide sleeve connected to the valve seat cage will be pushed along the positioning axis of the regulating member in the direction of the valve seat.

According to another preferred further development of the present invention, the regulating valve comprises an adjustable stop against which the guide sleeve bears under the pretension of a first spring, which keeps the guide sleeve pretensioned in the direction of the expansion element. The stop is usually defined by an adjusting ring screwed into a valve upper part, the valve upper part being inserted in a bore of the valve housing. The stop can be adjusted by adjusting the screw-in height of the adjusting ring and is formed by the lower surface of the adjusting ring. A collar of the guide sleeve is pressed in the direction of this surface by the first spring, which is supported in the valve upper part. The spring force of the second spring is adjusted such that the collar of the guide sleeve will bear against the lower surface of the adjusting ring during the regulating operation. During the disinfection operation of the regulating valve, the first spring is compressed due to the fact that the regulating member bears against the base of the valve seat cage and the expansion element expands further, because the guide sleeve is connected to the valve seat cage so that the collar of the guide sleeve will lift off the lower surface of the adjusting ring. When the water temperature decreases again after thermal disinfection, the expansion element shortens, so that the collar of the guide sleeve will again be pressed against the stop by the first spring.

As a result, also the valve seat cage will again be pulled back into the valve seat, i.e. inserted into the valve seat in the direction of the expansion element.

According to another preferred further development of the present invention, the regulating valve comprises a second spring, which has a spring force smaller than that of the first spring and which keeps the expansion element pretensioned against the guide sleeve. The expansion element expands during the regulating operation against the spring force of the second spring and displaces the regulating member in the guide sleeve in the direction of the positioning axis towards the flow-through opening of the valve seat cage or away from the flow-through opening. This leads to the water-temperature-dependent axial positioning movement of the regulating member for regulating the water flow rate during the regulating operation, which axial positioning movement has already been described at the beginning. The spring forces of the first and second springs are here adapted to each other in such a way that, in the regulating operation, the collar of the guide sleeve will not lift off the stop due to an expansion of the expansion element. The spring force of the second spring is therefore smaller than that of the first spring.

Further details and advantages of the present invention can be seen from the description of an embodiment in combination with the drawing following hereinafter.

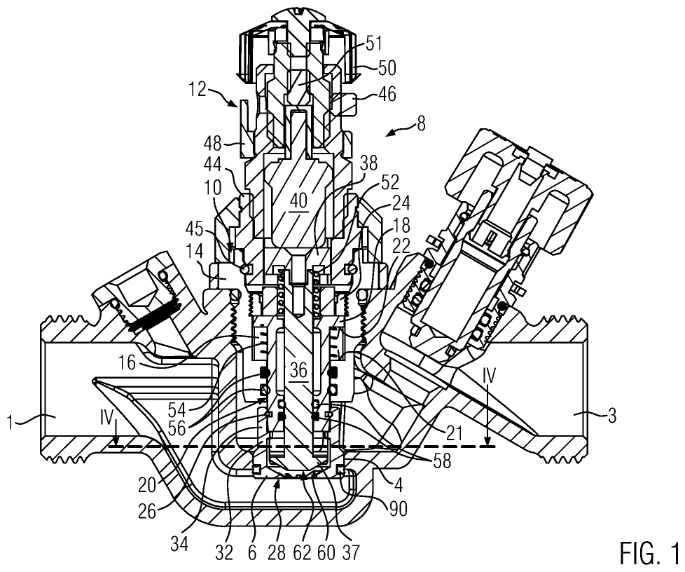

FIG. 1 shows a longitudinal sectional view of the embodiment during the regulating operation,

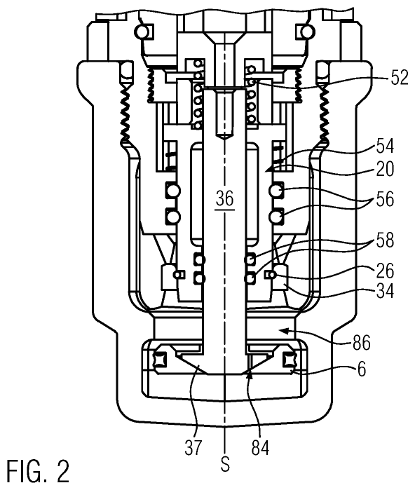

FIG. 2 shows an enlarged detail of the longitudinal sectional view of the embodiment during the disinfecting operation,

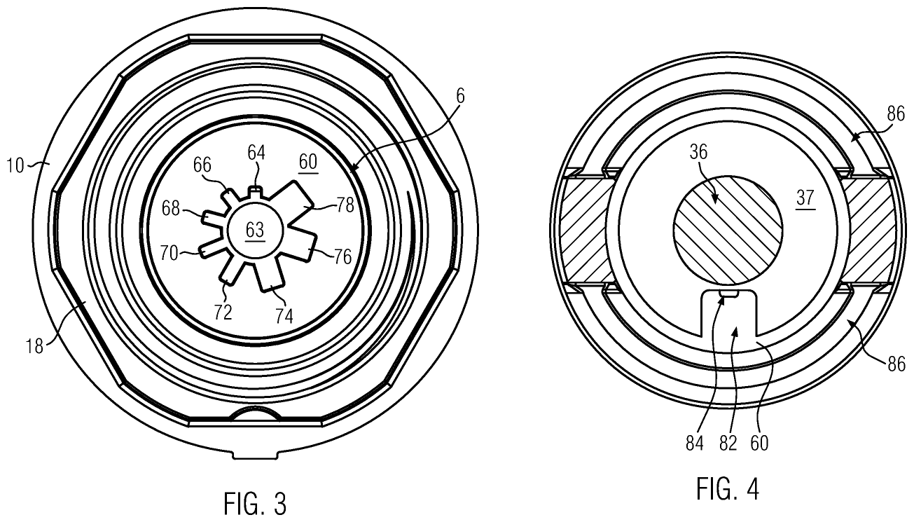

FIG. 3 shows a top view from above down to the base of the valve seat cage, with the plunger removed, and

FIG. 4 shows a sectional view of the valve seat cage according to line IV-IV of the representation in FIG. 1.

The regulating valve according to the present embodiment has a valve housing 2, which forms a valve seat 4 between an inlet channel 1 and an outlet channel 3. The valve seat 4 has provided therein a lower ring 6 of a valve insert 8, the ring 6 bearing against the valve seat 4 during a regulating operation of the regulating valve.

The valve insert 8 is inserted into the valve housing 2 as a prefabricated component, and has a lower assembly 10 and an upper assembly 12. The lower assembly 10 comprises a lower valve insert housing 14, which forms a reception means 16 in which a collar 18 of a guide sleeve 20 is movable between two stops, a lower stop 21 being defined by the lower valve insert housing 14 itself and an upper stop 22 being defined by the lower surface of an adjusting ring 24 screwed into the lower valve insert housing 14. The end of the guide sleeve 20 facing the valve seat 4 is connected via a snap ring 26 to a valve seat cage 28, which forms the lower ring 6 at its free end. This lower ring 6 of the valve seat cage 28 is connected via webs 32 to an upper ring 34, which receives the snap ring 26 therein for connection to the guide sleeve 20.

A plunger 36 extends through the guide sleeve 20, the plunger 36 being provided as an example of a regulating member according to the present invention and being movably guided in an axial direction of the valve insert 8 and thus along a positioning axis S. The free lower end of the plunger 36 has a frustoconical cap 37. The opposite end of the plunger 36 cooperates with a thermal placement element in the form of an expansion element 40 via a plate 38. This expansion element 40 is accommodated in the upper assembly 12. The upper assembly 12 has an upper valve insert housing 44, which, via a snap ring 45, is connected to the lower valve insert housing 14 in an axially fixed but rotatable manner. The upper assembly 12 additionally has a union housing 46 enclosing the expansion element 40 therein and connected to an operating element 48 in a rotationally fixed manner. A handwheel 50 cooperates with a spindle 51, which displaces the expansion element 40 within the upper assembly 12 axially, i.e. along the positioning axis, so as to change the temperature dependence of the regulating valve. In the present case, the operating element 48 is an indicator ring indicating, together with the lettering of the handwheel 50, the set temperature.

The collar 18 of the guide sleeve 20 has a substantially polygonal outer circumferential surface accommodated in a correspondingly shaped inner circumferential surface of the lower valve insert housing 14, which surrounds the reception means 16. In this way, the guide sleeve 20 is movable axially, but not rotationally, within the valve insert 8.

The upper assembly 12 can be rotated relative to the lower assembly 10 on the basis of the connection via the snap ring 45. However, the two assemblies 10, 12 are axially fixed relative to each other.

The valve insert 8 has an upper restoring spring 52, which bears with one side against a surface of the guide sleeve 20 facing the expansion element 40 and with the other side against an opposite lower surface of the plate 38 and which, accordingly, forces the plate 38 into contact with the thermal placement element 40 under pretension. The valve insert 8 has a lower restoring spring 54 arranged in the reception means 16 and held under pretension between the base of the reception means 16 and the collar 18 of the guide sleeve 20. Below this lower restoring spring 54, the guide sleeve 20 is sealed with respect to the lower valve insert housing 14, relative to which the guide sleeve 20 is axially movable, by two sealing rings 56. Additional sealing rings 58 seal the plunger 36 against the guide sleeve 20.

The restoring force of the lower restoring spring 54 is greater than the restoring force of the upper restoring spring 52. Hence, an expansion of the expansion element 40 from the initial position shown in FIG. 1 will initially have the effect that the plunger 36 moves in the direction of the lower ring 6. Only after the plunger 36 has come into contact with the base 60 of the valve seat cage 28, which is circumferentially enclosed by the lower ring 6, will the valve seat cage 28 be entrained together with the guide sleeve 20. This relative movement will only take place when, within the flow channel for hot water predefined by the valve, temperatures occur within the range of the temperature interval for thermal disinfection (cf. FIG. 2). During the regulating operation, i.e. when the hot water temperatures are below the temperature for thermal disinfection, only the plunger 36 is moved through the expansion element 40.

FIG. 3 shows a top view from above of the lower valve housing down to a base 60 of the lower ring 6 without the plunger 36. This base 60 tapers conically, in correspondence with the frustoconical design of the plunger 36, and has a flow-through opening 62 defining an axial inlet opening for the water flow through the valve housing 2. Distributed around the circumference of a circular center hole 63 of the flow-through opening 62, a plurality of radially extending slots 64-78 are formed, which radially enlarge the center hole 63 sectionwise.

The free, enlarged end of the plunger 36, which is configured as a cap 37, has a substantially disk-shaped cross-sectional area provided with a radially inwardly extending cutout 82 on a circumferential segment thereof. FIG. 4 shows a sectional view of the valve seat cage 28 together with the plunger 36 on the level of the webs 32 with the underlying base 60 of the lower ring 6.

The overlap between the cutout 82 and, in the present case, the radial slot 64 leads to a comparatively small regulating gap 84, which defines the cross-section for allowing a residual volume flow to pass therethrough. The residual volume flow is also allowed to pass through the flow-through opening 62 of the valve seat cage 28 when the plunger 36 bears with its cap 37 against the base 60 and the valve is closed under thermal control through the expansion element 40. By pivoting the upper assembly 12 relative to the lower assembly 10, the cutout 82 can be brought into overlap with a respective different one of the radial slots 64-78. The size of the regulating gap 84, and thus the residual flow rate, can be adjusted in this way.

Starting from the initial position shown in FIG. 1, the expansion element 40 will expand in response to an increase in the temperature of the water flowing through the valve. This has the effect that the plunger 36 will be displaced in the direction of the valve seat 4 and the valve seat cage 28 bearing against the valve seat 4. Even if the cap 37 is abutted on the base 60 of the lower ring 6, the regulating gap 84 between the valve seat cage 28 and the plunger 36 will remain open so that the residual volume flow can pass therethrough. If the temperature of the water flowing through the valve increases still further, a further expansion of the expansion element 40 will cause an advance movement of the plunger 36, which will entrain the valve seat cage 28 and the guide sleeve 20 against the restoring force of the lower restoring spring 54. Finally, the lower ring 6 will be pushed out of the valve seat 4 on the side opposite the expansion element 40, so that transverse openings provided between the webs 32 and identified by reference numeral 86 will be exposed below and above the valve seat 4, thus allowing thermal disinfection with comparatively high volume flows through the valve (cf. FIG. 2).

### LIST OF REFERENCE NUMERALS

1 inlet channel
2 valve housing
3 outlet channel
4 valve seat
6 lower ring
8 valve insert
10 lower assembly
12 upper assembly
14 valve insert housing
16 reception means
18 collar
20 guide sleeve
21 lower stop
22 upper stop
24 adjusting ring
26 snap ring
28 valve seat cage
32 webs
34 upper ring
36 plunger
37 cap
38 plate
40 expansion element
44 upper valve insert housing
45 snap ring
46 union housing
48 operating element
50 handwheel
51 spindle
52 upper restoring spring
54 lower restoring spring
56, 58 sealing rings
60 base
62 flow-through opening
63 center hole
64-78 slots
82 cutout
84 regulating gap
86 transvers openings
90 sealing ring
S positioning axis

1. A regulating valve for water circulation systems, comprising a valve housing (2) having an inlet channel (1) and an outlet channel (3) and forming a valve seat (4) between the inlet channel (1) and the outlet channel (3), a regulating member (36) movable relative to the valve seat (4) for regulating a water flow rate, and an expansion element (40) controlled by a water temperature for placement control of the regulating member (36), wherein a valve seat cage (28) bearing against the valve seat (4) during a regulating operation forms a flow-through opening (62) relative to which the regulating member (36) is movable, the regulating member (36) being pivotable about its positioning axis (S) for presetting a regulating gap (84) between the regulating member (36) and the valve seat cage (28).

2. The regulating valve (2) according to claim 1, wherein the regulating gap (84) can be varied stepwise by pivoting the regulating member (36).

3. The regulating valve (2) according to claim 1, wherein the regulating member (36) is pivotable through essentially 360°.

4. The regulating valve (2) according to claim 1, wherein, for regulating the water flow rate, the regulating member (36) cooperates with a base (60) of the valve seat cage (28) provided with the flow-through opening (62), and that the regulating gap (84) is defined by a part of the flow-through opening (62) which, when the regulating member (36) bears against the base (60), is not covered by the regulating member (36).

5. The regulating valve (2) according to claim 4, wherein the end of the regulating member (36) cooperating with the base (60) is conical and the base (60) forms a counter-cone thereto.

6. The regulating valve (2) according to claim 4, wherein the flow-through opening (62) of the base (60) has a center hole (63) from which differently sized slots (64, 66, 68, 70, 72, 74, 76, 78) extend in a radial direction.

7. The regulating valve (2) according to claims 5 and 6, wherein the conical end of the regulating member (36) has a radially inwardly extending cutout (82) which can be brought into overlap or overlay with one of the slots (64, 66, 68, 70, 72, 74, 76, 78) by pivoting the regulating member (36), so as to adjust the regulating gap (84) stepwise.

8. The regulating valve (2) according to claim 1, wherein, in a disinfecting operation for thermal disinfection of the regulating valve (2), the valve seat cage (28) can be moved, at least partially, to a side of the valve seat (4) located opposite the expansion element (40).

9. The regulating valve (2) according to claim 8, wherein, during the disinfecting operation, a ring (6) provided at the free end of the valve seat cage (28) and having at its outer circumference a seal (90) cooperating with the valve seat (4) is forced through a passage opening of the housing by the regulating member (36), the passage opening of the housing being defined by the valve seat (4).

10. The regulating valve according to claim 1, wherein a guide sleeve (20) in which the regulating member (36) is displaceably guided and sealed and which carries the valve seat cage (28).

11. The regulating valve according to claim 10, further comprising an adjustable stop (22) against which the guide sleeve (20) rests under the pretension of a first spring (54), which keeps the guide sleeve (20) pretensioned in the direction of the expansion element (40).

12. The regulating valve according to claim 11, further comprising a second spring (52) having a spring force which is smaller than that of the first spring (54) and keeping the expansion element (40) pretensioned against the guide sleeve (20).
